(19) United States
(12) Patent Application Publication
(10) Pub. No.: US 2004/0055946 A1
(43) Pub. Date: Mar. 25, 2004

(54) Dual filtration system

(75) Inventor: Richard Schmidt, Islip Terrace, NY (US)

Correspondence Address: Yuri Kateshov, Esq., DILWORTH & BARRESE, LLP, 333 Earle Ovington Blvd., Uniondale, NY, 11553, US

(73) Assignee: SID HARVEY INDUSTRIES, INC., Valley Stream, NY

(21) Appl. No.: 10/251,040

(22) Filed: Sep. 20, 2002

(51) Int. Cl. B01D 27/00

(52) U.S. Cl. 210/314

(57) ABSTRACT

A multi-filtration system for sequential decontamination of fluid includes a plurality of filters operating at different rates of decontamination and rigidly interconnected with one another to filter contaminants of different sizes as the fluid is delivered to a fluid-consuming component.

### BACKGROUND

1. Technical Field

The invention relates to fuel oil filtration technology, and particularly to a dual filtration assembly capable of sequentially filtering fluid at different rates to minimize the presence of contaminants in the filtered fluid.

2. Background of Related Art

With the speedy development of science, technology and industries, the demands of the degree of purification and refinement for industrial oils, such as crude, lubrication and/or heating oils, are becoming increasingly strict and, also the amount of oils consumed grows daily. Subsequently, in industries, the refinement of oils not only has to be up to the stipulated standards, but the discarding of waste oils is not permissible by environmental laws and the law on the utilization of resources as well. Furthermore, this is also impractical in consideration of production cost. Thus, the processing of huge amounts of oils are involved. In addition, when being used, the oils are also being contaminated at a high speed. Therefore, for oils in the process of being used, continuous purification is also needed to ensure normal operation of the equipment. Contamination of the oils can produce great damage. One of the most harmful contaminants in oils are solid particles

Fluid filters, reclaimers or purifiers of various constructions have been proposed for removing both solid and liquid contaminates from fluids including oil and fuel. Fluids and oils do not wear out once the solids or volatile contaminates are removed therefrom, and, once decontaminated, most oils and industrial fluids are suitable for continued use.

Customarily, heating oil is decontaminated by an arrangements that typically removes various contaminates including differently sized solid and semi-solid particles, asphaultants, chlorides, salts, ammonia, and other volatile components from the oil or fluid in more than one pass, because the proposed arrangements do not remove more than one type of contaminates from the fluid or oil being purified or cleaned in one pass. Thus, if installed alone, most proposed devices are not “purifiers” in a technological sense and few, if any, currently available apparatus or proposed processes efficiently remove the above noted types of contaminates from industrial fluid or oil.

Yet a further disadvantage of the proposed arrangements resides in the fact that by virtue of the complex nature of a majority of the existing apparatus, such apparatus tends to lose their efficiency in removing contaminates and maintaining operation over extended periods of time requires constant maintenance attention. As a result, the fuel oil industry continues to identify clogged and partially clogged nozzles of furnaces as the primary cause of nuisance no-heat calls and excess soot development.

Furthermore, none of the proposed apparatus or processes designed to remove all types of the solids, semi-solids or other contaminates from oil or fluid has a simple structure that can be easily installed and maintained.

None of the proposed processes or apparatus are designed to effect the high efficiency of the removing of the solid, semi-solid, chlorides, salts, ammonia, and other volatile contaminates out of oil or fluid products to be purified or cleaned with a relatively maintenance free operation of the apparatus and, generally, the proposed processes and apparatus frequently become overloaded with contaminates thereby causing either a complete shutdown, a bypassing of portions of the apparatus or greatly reduced flow rates.

### 3. SUMMARY OF THE INVENTION

This invention involves an improvement over old methods of decontaminating and cleaning heating oil by introducing a multi-filtration system providing sequential filtering of solid, semi-solids and other contaminants of different sizes, which are typically contained in oil, to at least minimize concentration of the contaminants flowing through the nozzle into the burner.

In accordance with one aspect of the invention, the multi-filtration system includes a combination of at least two filters being detachably coupled to one another to provide for the sequential filtering of oil and other industrial fluids that need to be purified. Preferably, the filters are coupled in a manner excluding their displacement relative to one another. The filters are positioned close to one another and are interconnected by a nipple having a solid body made from metal or abrasion-resistant plastic.

One of the obvious advantages of the inventive assembly is that it thoroughly filters oil and, thus, reduces service calls for clogged, fouled nozzles and cleaner burning boilers and furnaces. Still another advantage of the inventive multi-filtration system is the improved serviceability of oil-conveying components, such as nozzles, injecting tubes and the like, leading, in turn, to fewer changes of these components. As a consequence, the inventive multi-filtration system is both maintenance-friendly and cost-efficient. A further advantage of the inventive system is that the nipple is more durable due to the fact that first, at least a part of contaminants, namely large-dimensioned particles, have been removed from a stream. Accordingly, the probability of damaging the nipple made from abrasion-resistant material is greatly reduced. Also, having the nipple relatively short, does not negatively affect the velocity of oil flow. Still a further advantage of the inventive multi-filtration system is that it can be installed and used with both new installations and retrofits.

According to another aspect of the invention, the entire assembly is mounted in close proximity to a burner. Such an arrangement allows the filters to be serviced simultaneously with a burner without spending a lot of extra time and provides additional convenience during installation and further maintenance of both the burner and the multi-filtration system.

Still another aspect of the invention relates to a mounting component of the inventive multi-filtration system. Typically, while dealing with heating oil, many of components including filters are mounted directly on soft, copper tubes. While inspecting, maintaining, and/or replacing the filters, the soft tubes can be easily deformed and, subsequently, damaged.

To minimize the risk of damaging the copper tubes, the inventive assembly includes a bracket that, once mounted on a support-bearing surface, allows for easy access to the filters without the need of touching the tubes.

### OBJECTS OF THE INVENTION

It is an object of the present invention to provide a multi-filtration system having an ability to decontaminate fluid at different rates to sequentially remove differently dimensioned solids and semi-solids from the passing fluid.

Another object of the intention is to provide a multi-filtration system that is convenient in use and is easy to maintain.

Still another object of the invention is to provide a multi-filtration system that can be easily mounted and dismounted without damaging existing support structures.

Yet another object of the invention is to provide a multi-filtration system capable of being installed on existing and newly manufactured structures.

### BRIEF DESCRIPTION OF THE DRAWINGS

The above and other object, features and advantages will become more readily apparent from the detailed description of a preferred embodiment discussed in conjunction with the following drawings, in which:

FIG. 1 is an isometric view of the multi-filtration inventive assembly;

FIG. 2 is a view of a spin-on filter; and

FIG. 3 is an exploded view of the inventive filtration system with amounting bracket.

### SPECIFIC DESCRIPTION

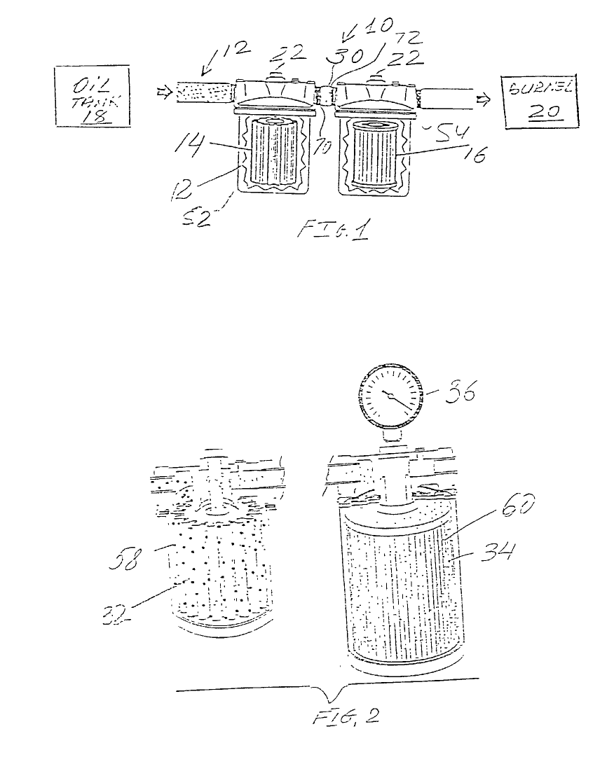

Referring to FIG. 1, a multi-filtration system 10 is installed between an oil tank 18 and a burner 20 and operates to filter heating supplied from the oil tank to the burner, typically equipped with a nozzle assembly, now shown in the drawings. A stream of oil 12 flows along an oil path through a primary filter 14, which is preferably MicroFlow® spun filter filtering at a rate of 50 microns, and then through a secondary filter 16, which is optionally a 10 micron Spin-On® filter. The primary 14 and secondary filters 16 are coupled to one another by a nipple 30 preventing relative displacement between the filters and providing flow therebetween.

Thus, the multi-filtration system 10 provides subsequent decontamination of oil 12 by first, removing solid, semi-solid and other contaminants having a relatively large size from the stream of oil, and then, by utilizing the secondary filter 16, cleaning oil 12 from articles having a finer size.

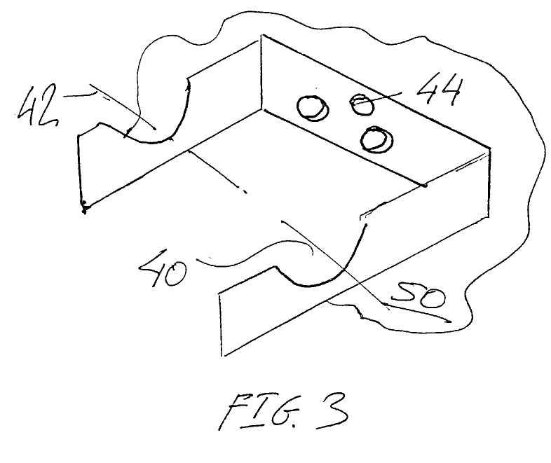

Each of the filters has a respective rate at which it provides filtering and includes a housing 52 provided with a removable lid 54. The lid 22 is screwed to the housing by a nut 22 and, when unscrewed, provides access to the interior of the housing 52. A replaceable cartridge 32 (FIG. 2) is made from fiber, which can reach up to a 1″ thickness and is provided with orifices 58 having a desired size. The stream of oil 12 introduced into the interior of the primary filter 14 and runs around the outer periphery of the cartridge 32. As the circulating oil gradually penetrates radially inwards, the oil is being filtered so that when the purified stream of oil 12 exits through a centrally positioned outlet, the oil is free from a great mass of large-dimensioned solids and semisolids having a size greater than the size of the orifices 58, which are, thus, confounded within the interior of the filters.

The secondary filter 16 structured similarly to the primary filter 14 but is provided with a relatively thin pleaded paper having orifices with a substantially smaller size to provide final removal of the particles that have not been captured by the primary filter. In use, the cartridges of both filters can be easily replaced without dismounting the entire assembly.

The nipple 30 is relatively short and dimensioned to provide minimal resistance to flow of the oil 12. The nipple is easily and removably attached to outlet 70 and inlet 72 ports formed in the primary and secondary filters, respectively. The body of the nipple 30 can be made from metal or plastic.

To ensure a proper functioning of the entire system, at least one vacuum gauge 36 is installed along an oil path. Preferably, the vacuum gauge 36 is detachably coupled to the secondary filter 16 and, as the both filters tend to reduce their filtering capacities, the gauge reliably indicates when either one or both filters require changing. Optionally, each filter may be provided with a respective vacuum gauge.

Thus, the multi-filtration system provides effective and efficient refinement of oil and allows almost pristine cleaning thereof prolonging, thus, the service life of process equipment.

Turning to FIG. 3, at least one mounting bracket 50 can be attached to any support bearing structure located in close proximity to the burner 20 and is provided with a U-shape. Defined between opposite tabs 40, 42 is a space receiving one of the primary and secondary filters of the above-disclosed inventive system 10. The other filter, thus, can be mounted on the same bracket, but on the outer side of one of the tabs. If any of the multi-filtration system's components requires attention, the assembly can be easily dismantled, while the bracket remains fixed to the support-bearing surface. Accordingly, the support-bearing structure, which is typically soft, copper tubes, remains intact. The bracket can be slightly modified by introducing an intermediate tab between the tabs 40 and 42 to provide a mounting space within which both the primary and secondary filters are mounted.

The foregoing specification describes only the preferred embodiment of the invention. Other embodiments besides the one described and shown may be articulated as well. The terms and expressions therefore serve only to describe the invention by example only and not to limit the invention. It is expected that others will perceive differences which while differing from the foregoing, and which may include different types of oil and industrial fluids as well as various modification of filters, do not depart from the spirit and scope of the invention herein described and claimed.

What is claimed is:

1. A multi-filtration system for decontaminating fluid comprising spaced primary and secondary filters located along a flow path of fluid and detachably attached to one another to provide sequential decontamination of the fluid at different purifying rates.

2. The system according to claim 1, wherein the primary filter is capable of removing contaminants having a relatively large size from the fluid exiting the primary filter, and as the partially filtered fluid flows through the secondary filter, the contaminants having a relatively small size that have not been captured by the primary filter are detained within the secondary filter.

3. The system according to claim 1, further comprising a nipple providing a flow communication between the primary and secondary filters.

4. The system according to claims 2, wherein the nipple is relatively short and made form non-flexible abrasion-resistant material.

5. The system according to claims 2, wherein the nipple is detachably coupled to the primary and secondary filters.

6. The system according to claim 1, wherein each of the primary and secondary filters includes a housing defining an interior, the primary filter including a cartridge made from a relatively thick fiber material, whereas, the secondary filter has a pleated paper element.

7. The system according to claims 1, wherein the fiber material is provided with a plurality of orifices having a relatively large diameter, whereas the secondary filter has the pleated paper element provided with an array of orifices having a relatively small diameter.

8. The system according to claim 1, further comprising a mounting bracket having a U-shape and removably mountable to a support bearing surface, which is located close to a burner, the mounting bracket being shaped and sized to receive and support the primary and secondary filters.

9. The system according to claim 8, wherein the mounting bracket is provided with an intermediate tab arranged between opposite sides of the bracket to define a respective mounting space for each of the primary and secondary filters.

10. The system according to claim 7, further comprising at least one vacuum gauge installed along the flow path and being in flow communication with the primary and secondary filters to indicate the degree of clogging of the orifices.

11. The system according to claim 10, wherein the at least one vacuum gauge is spaced downstream from the secondary filter and is removably attached to an outlet thereof.

12. The system according to claim 10, wherein each of the primary and secondary filters is provided with a respective vacuum gauge.
